(19) United States
(12) Patent Application Publication
(10) Pub. No.: US 2006/0095432 A1
(43) Pub. Date: May 4, 2006

(54) Disclosure control system and method

(75) Inventor: Takehisa Iwasaki, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/064,906

(22) Filed: Feb. 23, 2005

(30) Foreign Application Priority Data
Oct. 28, 2004 (JP) 2004-314063

(51) Int. Cl. G06F 17/30

(52) U.S. Cl. 707/7

(57) ABSTRACT

A service change information acquisition program acquires service change information. According to this information, a disclosure scope change program changes the disclosure scope of the document described in document access control information and accumulates it as a disclosure history. A position information acquisition program compares the position information to the former position information. If they are different, the program records a new position, the move-out date, and the move-in date, and accumulates them as a rotation history. An access control program correlates the disclosure history of the document described in the document access information with the rotation history of the person intending access described in the rotation history and allows access to the document which was disclosed while the person intending access belonged to the disclosure department.

### INCORPORATION BY REFERENCE

The present application claims priority from Japanese application JP2004-314063 filed on Oct. 28, 2004, the content of which is hereby incorporated by reference into this application.

### BACKGROUND OF THE INVENTION

1. Field of the Invention

The present invention relates to a disclosure control system and a disclosure control method and in particular, to a disclosure control system capable of presenting information while limiting a range of information to be disclosed according to the characteristic of the information to be shared.

2. Description of the Related Art

Recently, the concurrence between enterprises and organizations has been intensified and it has become necessary to share and mutually re-utilize the knowledge and know-how owned by each person belonging to an enterprise or an organization so as to improve their work efficiency and capability. As a method to re-utilize knowledge and know-how, there is known a system (hereinafter, referred to as a knowledge sharing system) in which each user registers in advance his/her knowledge in the form of a document and the like in the knowledge sharing infra system so that other users can search and reference desired knowledge among the knowledge registered. The knowledge sharing system enables all the users to register information to be shared and search and reference desired information. On the other hand, it is possible to register information of high security to be shared only among limited members (hereinafter, referred to as exclusive information) and to search and reference it.

Normally, in order to prevent leak of the aforementioned exclusive information, the knowledge sharing system is configured by using the method to limit the users who can reference the information in the organization unit such as a department and a group. In this case, the department or group to which the reference is to be limited (hereinafter, referred to as a disclosure scope) is set for each document when information in the document is registered by a user. Reference of the exclusive information is enabled/disabled by correlating the disclosure department of the information with the department to which a user belongs. The disclosure department of a document is managed by a system administrator including change to another department when the organization is changed by modifying the department name or unifying departments.

It should be noted that as a related technique of the aforementioned knowledge sharing system, there is known a technique disclosed in JP-A-2003-91448.

### SUMMARY OF THE INVENTION

In the aforementioned related technique, when an organization change is executed such as change of a department name or division of the department, the personnel information containing definition of the position is automatically changed by the system. However, the disclosure department of the exclusive information remains as it has been unless it is changed by the system administrator and a user may not access desired exclusive information. In this case, the user who has been performing a job by using exclusive information cannot get information by using the knowledge sharing system and should acquire information by another method, which requires a plenty of time and lowers the efficiency of the work requiring the information.

Moreover, in the aforementioned related technique, when a user moves to another department which has another-job upon change of the organization, the user may continue to work on the former job after he has moved to the new department, which requires the exclusive information accessible by the department before the movement. However, the user after moving to the new department cannot reference the exclusive information and should use another method to get the information instead of using the knowledge sharing system, which lowers the efficiency of the work requiring the information.

In the aforementioned related technique, the access control is set in a unit of a department or a group and it is impossible to modify the disclosure department so that a user can reference the exclusive information without posing a load on the system administrator upon change of the organization. Moreover, in the aforementioned related technique, a user who has moved to another department cannot get the exclusive information accessible to the department to which the user belonged before. The user should ask another person to get necessary information, which significantly lowers the work efficiency.

It is therefor an object of the present invention to provide a disclosure control system for automatically setting a disclosure department to an appropriate department upon change of an organization and enabling a user who has moved to a new department can reference the exclusive information which could be accessed during the period when the user belonged to the former department. There is also provided a disclosure control method used in thus system.

The aforementioned object is achieved by a disclosure control system including a plurality of terminal devices which are used by users and a knowledge sharing server for storing information registered by a user and disclosing the information to a user upon request from the user. The terminal devices and the knowledge sharing server are connected via a network. The knowledge sharing server registers information from a plurality of users, discloses the registered information to a particular department to which a user belongs, references the job change information managing the job change in the aforementioned department, and modifying the department to which the information is disclosed, according to the job change information referenced, upon change of the organization.

Furthermore, the aforementioned object is achieved by a disclosure control method used in the disclosure control system including a plurality of terminal devices used by users and a knowledge sharing server for storing information registered by users and disclosing the information to a user upon request from the user, the terminal devices and the knowledge sharing server being connected by a network. The knowledge sharing server registers information from users, accumulates position histories of the users, and correlates the position histories with the information registration date and disclosure department so as to allow disclosure of information to a user if the information has been disclosed to the user during the period of the former position.

### BRIEF DESCRIPTION OF THE DRAWINGS

FIG. 1 is a block diagram showing configuration of a disclosure control system according to an embodiment of the present invention.

FIG. 2A-2F are diagrams showing configuration of various information records of a magnetic disc device and the entire-company information system.

FIG. 3 is a PDA (Problem Analysis Diagram) for explaining a document registration process.

FIG. 4 shows an example of screen displayed on the terminal device upon a document registration process.

FIG. 5A-5E show examples of department change pattern upon change of an organization and explains to which department the document disclosure scope is to be set.

FIG. 6 is PAD explaining a process for modifying the document disclosure department.

FIG. 7 is a PAD explaining a process for creating a rotation history.

FIG. 8 is a PAD explaining an access control process upon request of a document list.

FIG. 9 shows an example of a display screen of the document list of documents allowed to be referenced.

FIG. 10 shows an example of an access period selection screen for setting the access period according to the characteristics of the document.

### DETAILED DESCRIPTION OF THE INVENTION

Description will now be directed to preferable embodiments of the present invention with reference to the attached drawings. It should be noted that the present invention is not limited by the detailed explanation of the preferable embodiments.

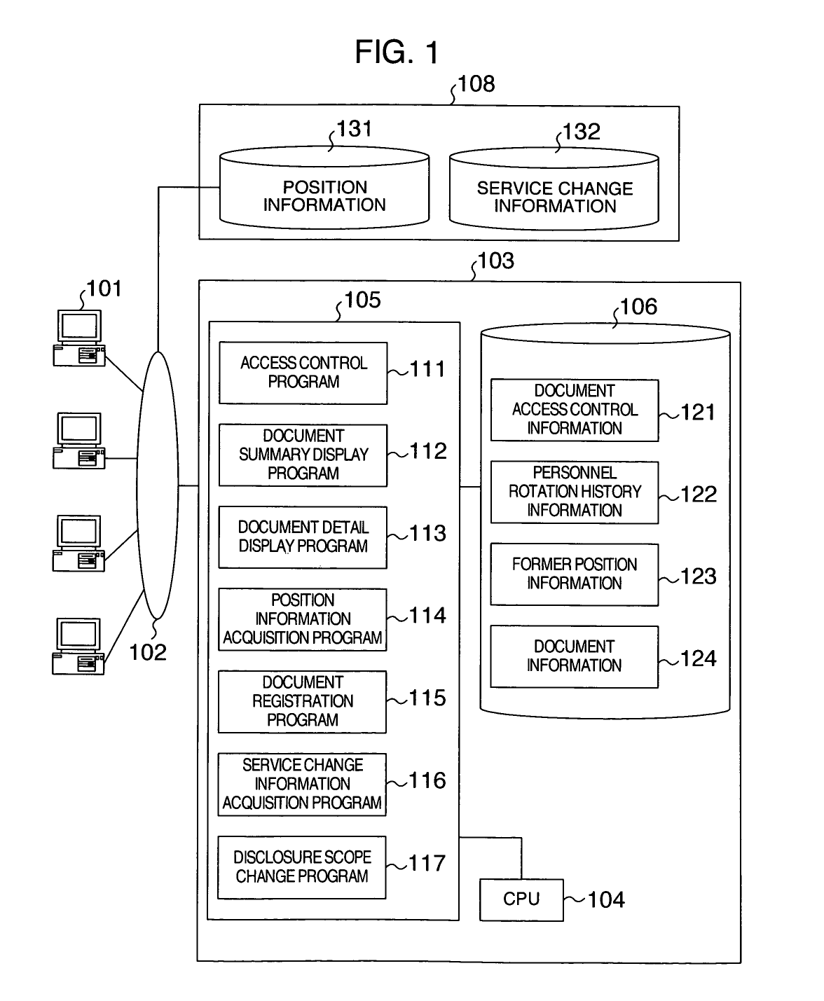

FIG. 1 is a block diagram indicating the configuration of the disclosure control system according to an embodiment of the present invention. The system includes terminal devices 101, a network 102, a knowledge sharing server 103, a central processing unit (CPU) 104, a main memory 105, a magnetic disc device 106, an entire-company information system 108, an access control program 111, a document summary display program, a document detail display program 113, a position information acquisition program 114, a document registration program 115, a service change information acquisition program, disclosure scope change program, document access control information 121, personnel rotation history 122, former position information 123, document information 124, position information 131, and service change information 132.

The disclosure control system shown in FIG. 1 includes a plurality of terminal devices 101 for receiving an input from a user and outputting a document list and the knowledge sharing server 103 having knowledge information to be shared and providing the knowledge information to a user. The terminal devices 101 and the knowledge sharing server 103 are connected via the network 102 such as the Internet and the Intranet. The terminal device 101 may be composed of a PC (Personal Computer) including, as is well known, a CPU, a main memory, an HDD, an FD, an input device such as a keyboard, and a display device. The terminal device 101 accesses the knowledge sharing server 103 via the network 102 so as to perform various operations from the terminal device 101. Moreover, the network 102 of the disclosure control system shown in the figure is connected the entire-company information system 108 managing personnel information in an organization and information on the organization. The entire-company information system 108 contains position information 131 containing positions of the users using the knowledge sharing server 103 and the service change information 132 defining which service is assigned to which department upon organization change.

The knowledge sharing server 103 includes the CPU 104, the main memory 105, the magnetic disc device 106 and a bus 107 connecting them. The main memory 105 contains an access control program 111 for judging whether the document disclosure is to be enabled or disabled, the document summary display program 112 for displaying a document list containing a document title, a document disclosure department, the document detail display program 113 displaying detailed information such as a document content and various attributes, the position information acquisition program 114 for acquiring the position information 131 from the entire-company information system 108, the document registration program 115 for registering a document in a master, the service change information acquisition program 116 for acquiring the service change information 132 from the entire-company information system 108 each time the organization is changed, and the disclosure scope change program 117 for changing the disclosure department to an appropriate department according to the service change information 132. These programs stored in the main memory 105 are normally stored in the magnetic disc device 106, loaded onto the main memory when performing a process, and executed by the CPU 104 under OS (not depicted) loaded from the magnetic disc device 106.

The magnetic disc device 106 is one of the secondary storage devices and contains: document access control information 121 for recording a document ID, a disclosure department, and registration date; personnel rotation history 122 recording attributes such as the user's new department and the position change date; former position information 123 recording the user's position up to the preceding date; and document information 124 recording attributes such as a document ID and a document title, and a document file.

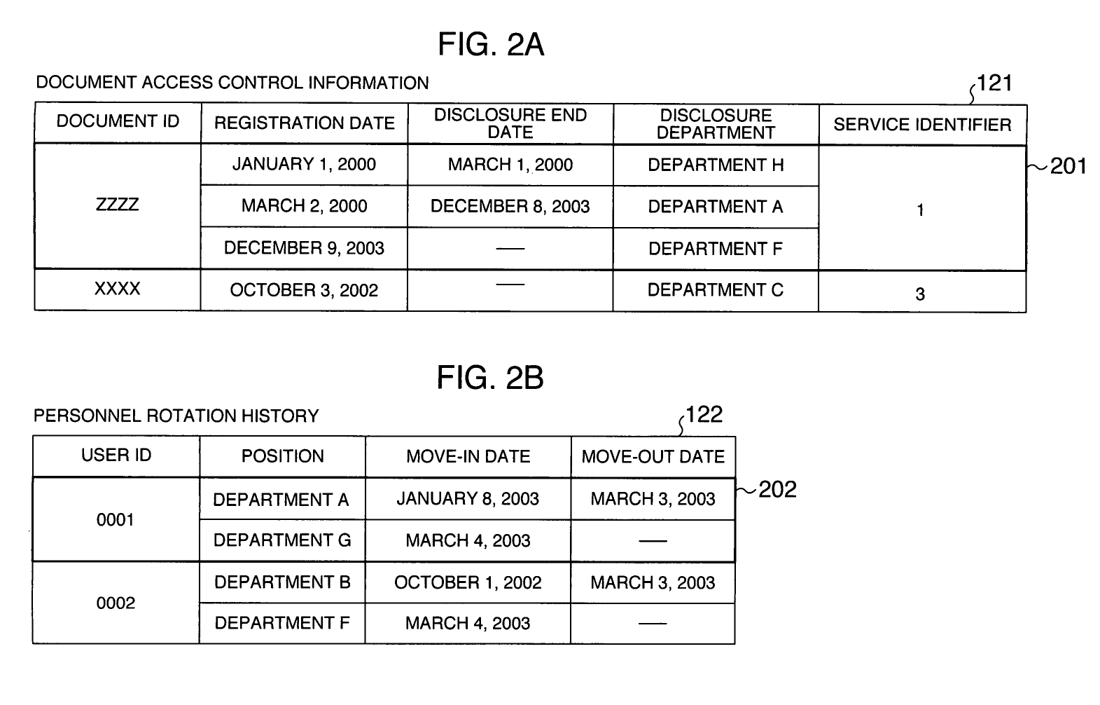

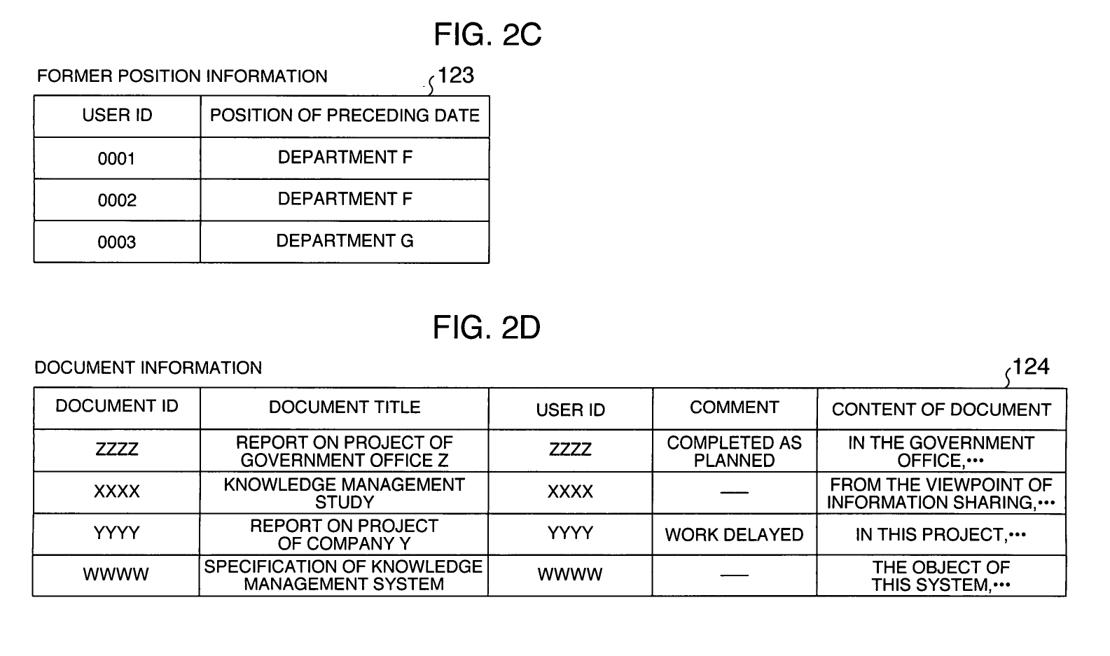

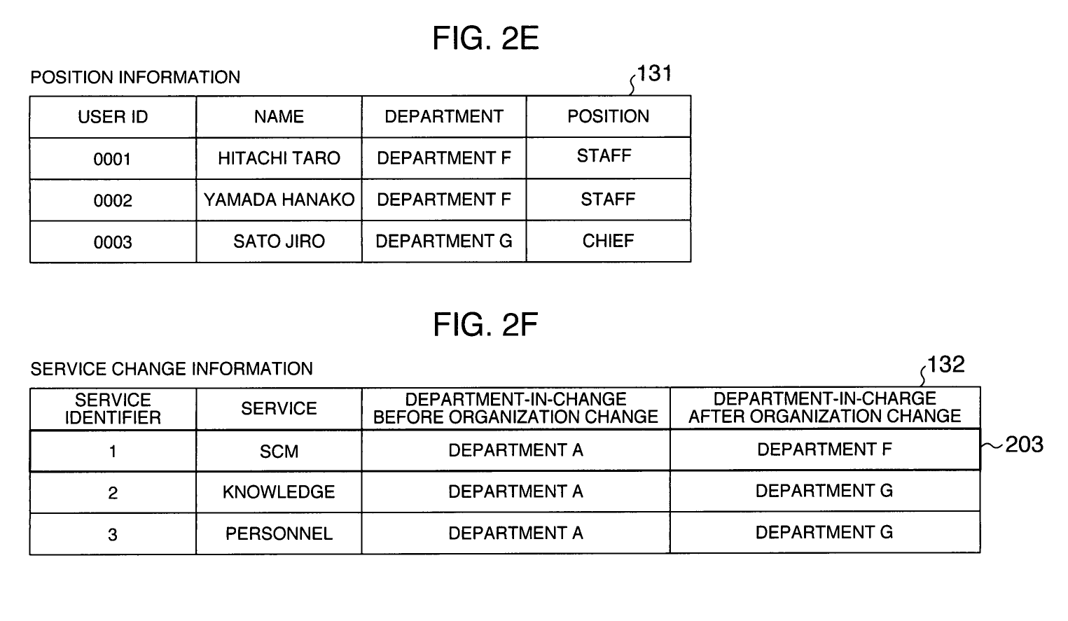

FIG. 2 shows configurations of various information records owned by the magnetic disc device and the entire-company information system. Next, explanation will be given on this.

As shown in FIG. 2A, the document access control information 121 consists of records, each containing a document ID, a registration date, a disclosure end date, a disclosure department, and a service identifier. As shown in FIG. 2B, the personnel rotation history consists of records, each containing a user ID, position, start date, and end date. As shown in FIG. 2C, the format position information 123 consists of records, each containing a user ID and a former position up to the preceding day. As shown in FIG. 2D, the document information 124 consists of records, each containing a document ID, a document title, a user ID of the person who performs registration, a comment, other document attributes and document contents. As shown in FIG. 2E, the position information 131 consists of records, each containing a user ID, a user name, position, and the like. As shown in FIG. 2F, the service change information 132 consists of records, each containing a service identifier for identifying the service, department before organization change, and department after the organization change. The service change information 132 is created upon an organization change for each of the services of the departments subjected to the organization change.

Next, the processing flow in the present embodiment will be explained by dividing it in the following four processes: a document registration process, a disclosure department change process, a personnel rotation information creation process, and an access control process.

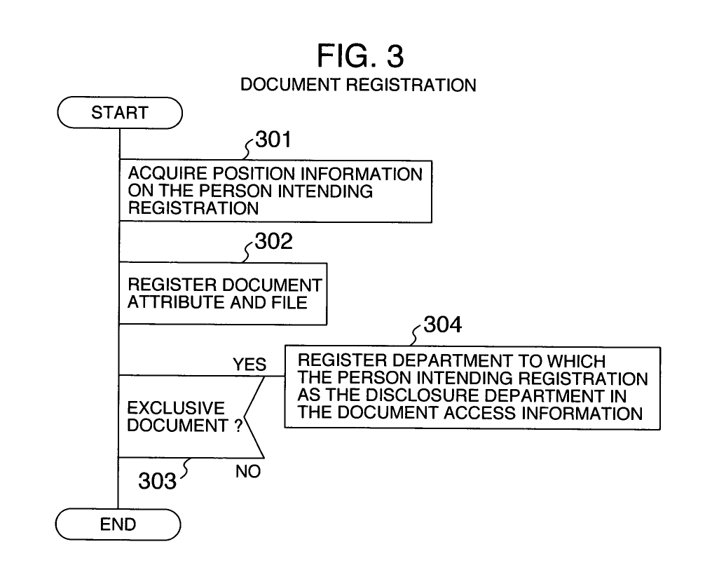

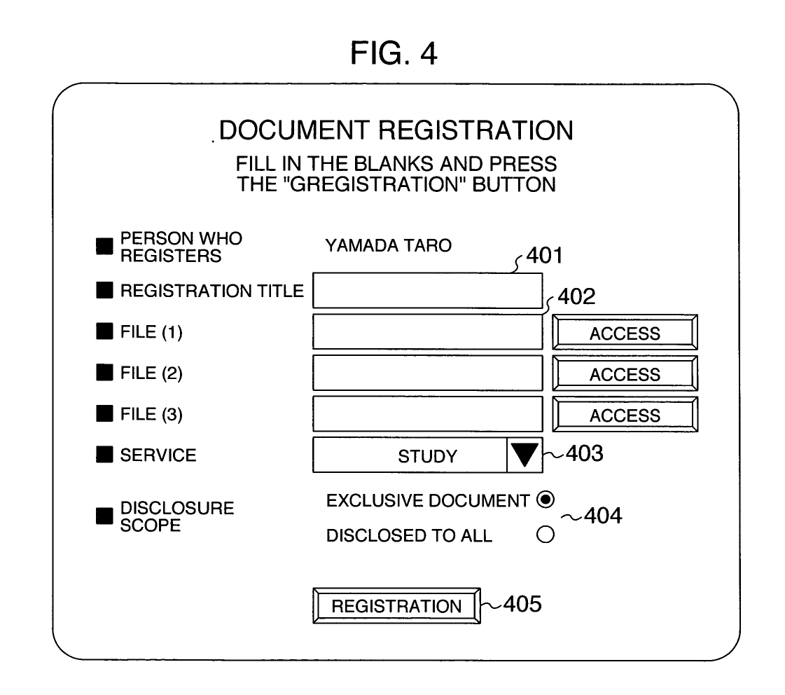

FIG. 3 is a PAD (Problem Analysis Diagram) explaining the operation of the document registration process in the present embodiment. FIG. 4 shows an example of a screen displayed on the terminal device 101 when registering a document. Referring to these figures, explanation will be given on the operation of a document registration process.

(1) When a user who wants to register a document as information to be shared accesses the knowledge sharing server 103 from the terminal device 101 and inputs a user ID, the position information acquisition program 114 accesses the entire-company information system 108 according to the user ID inputted and acquires the position information on the person intending to perform registration from the position information 131 (step 301).

(2) Next, the document registration program 115 is started. The program 115 stores in the document information 124 the document file containing attribute information such as the document ID, the document title, and the person intending to perform registration which have been inputted. The program judges whether the registered document is specified as an exclusive document by the person intending to perform registration. When the registered document is not an exclusive document, the registered document is judged to be disclosed to the all and the process is terminated (steps 302, 303).

(3) When step 303 judges that the registered document is an exclusive document, the document registration program 115 registers the document ID, the registration date, the service identifier, and the like in the document access control information 121, makes the position information acquisition program 114 acquire the department to which the person intending to perform registration belongs, and registers the department as a disclosure department (step 304).

In the aforementioned processing, when a user intending to register a document accesses the knowledge sharing server 103 from the terminal device 101, a screen for registering a document as shown in FIG. 4 is displayed on the terminal device 101. The user inputs a document title 401, a document file 402, and an object service 403 of the document, selects the exclusive disclosure check box 404 if necessary, and presses the registration button 405. Then, the aforementioned processes are executed.

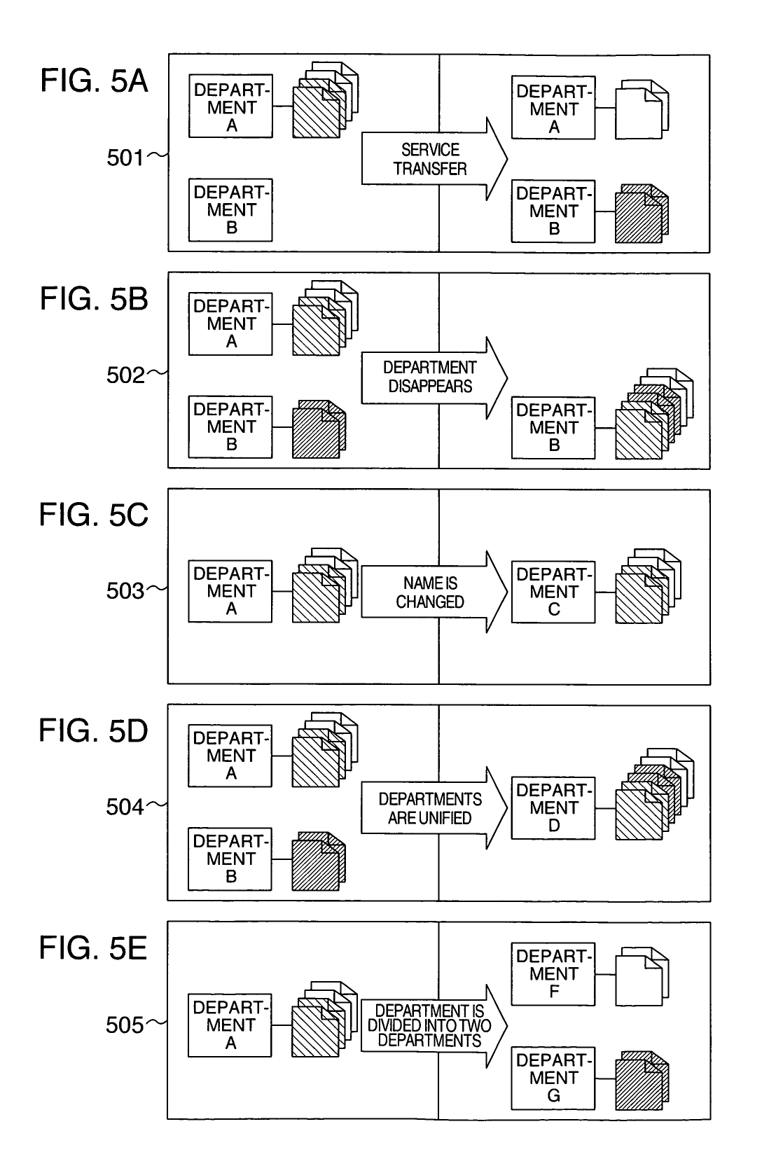

FIG. 5 shows examples of department change pattern upon an organization change as objects of the present embodiment and explains to which department the document disclosure scope is to be set. Next, referring to FIG. 5, explanation will be given on the disclosure department change.

FIG. 5A shows a case when a service is moved between departments. When a part of service belonging to department A is moved to department B, the document accompanying the service moved is disclosed in department B as a service movement destination (501). FIG. 5B shows a case when a department has disappeared and the service belonging to the department is moved to another department. When the department A disappears and the service belonging to the department A is moved to the department B, the document accompanying the service moved is disclosed in the department B as a service movement destination (502). FIG. 5C shows a case when a name of a department is changed. When the name of the department A is changed to department C, the document accompanying the service of the department A is disclosed in the department C after the name change (503). FIG. 5D shows a case that two departments are unified into one department. When the departments A and B are unified into a department D, all the documents belonging to the departments A and B are disclosed in the department D where the departments A and B are unified (504). FIG. 5E shows a case when a single department is divided into two departments. When the department A is divided into departments F and G, the service which has belonged to the department A is divided into the departments F and G and the documents accompanying the respective services are delivered so as to be disclosed in the respective departments F and G (505).

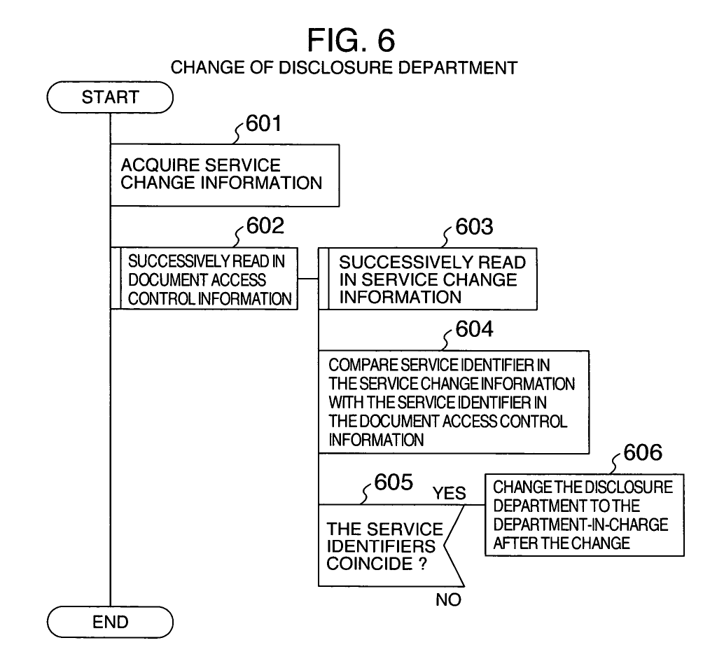

FIG. 6 is a PAD explaining the operation of the process for changing the document disclosure department. Next, referring to FIG. 6, explanation will be given on the process for changing the disclosure department. It should be noted that the explanation given here relates to the department division explained with reference to FIG. 5E.

(1) Firstly, when an organization is changed, the system administrator executes the service change information acquisition program 116 so that the service change information acquisition program 116 acquires the service change information 132 on the entire-company information system 108 (step 601).

(2) Next, the disclosure scope change program 117 is started. The disclosure scope change program 117 successively reads in the document access control information 121 for the number of documents and further successively reads in the service change information 132 on the entire-company information system 108 for the number of services changed (steps 602, 603).

(3) The service identifier of the service change information is correlated to the service identifier of the document stored in the document access control information 121 so as to judge whether the service identifier of the document coincides with the service identifier of the service change information (steps 604, 605).

(4) When step 605 judges that the service identifier of the documents coincides with the service identifier of the service change information, the current date is described in the document disclosure end date, a record is added, and the registration date and the disclosure department are described (step 606).

Next, referring to FIG. 2 and FIG. 6, explanation will be given on a specific example of the disclosure department change method.

Suppose that an organization is changed on Dec. 9, 2003. In this case, the document 201 of the document ID ZZZZ is read in from the document access control information shown in FIG. 2A (step 602). Moreover, information (203) having the service identifier 1 is read in from the service change information shown in FIG. 2F (step 603). The service identifier of the document ZZZZ is “1” and the document disclosure department should be changed because the service as an object is moved. Moreover, since the document ZZZZ terminates disclosure in the department A, the disclosure end date are set on Dec. 8, 2003, a line is added so that Dec. 9, 2009 is set as the registration date, and the department F is set as a new disclosure department.

By using the aforementioned process; it is possible to easily change the disclosure department of the exclusive document when an organization is changed. According to the present embodiment, it is possible to rapidly change the exclusive disclosure department and reference a necessary document simultaneously with the organization change.

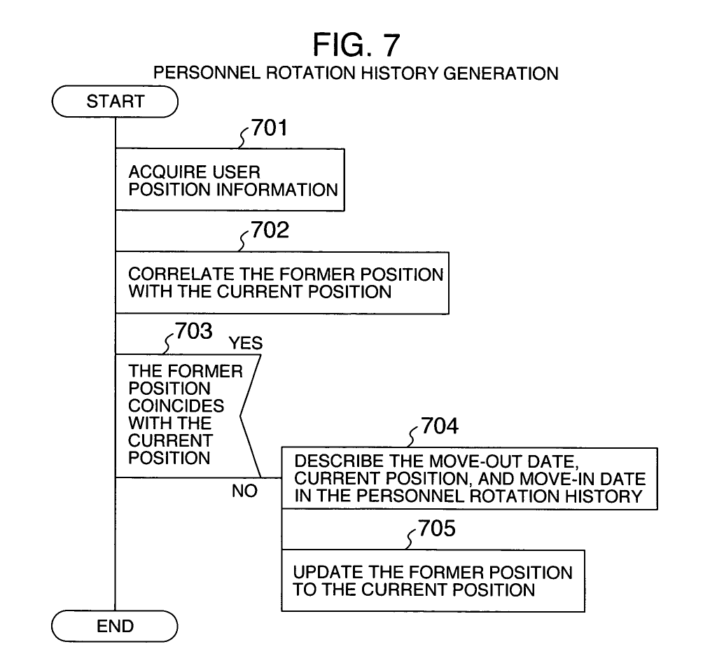

FIG. 7 is a PAD explaining operation of the personnel rotation history generation process. Next, referring to FIG. 7, explanation will be given on the operation of the personnel rotation history generation process. This process is performed by the position information acquisition program 114.

(1) The position information acquisition program 114 periodically (such as once a day) acquires the position information 131 on all the users participating in the disclosure control system according to the present embodiment, from the position information 131 of the entire-company information system 108 (step 701).

(2) Next, the position contained in the acquired position information 131 (hereinafter, referred to as a current position) is correlated to the position stored in the format position information 123 (hereinafter, referred to as a former position) so as to judge whether the current position coincides with the former position.

(3) When step 703 judges that the current position does not coincide with the former position, the user move-out date of the personnel rotation history 122 is described, and a record is added so as to describe the current position and move-in date. The former position is updated to the current position (steps 704, 705).

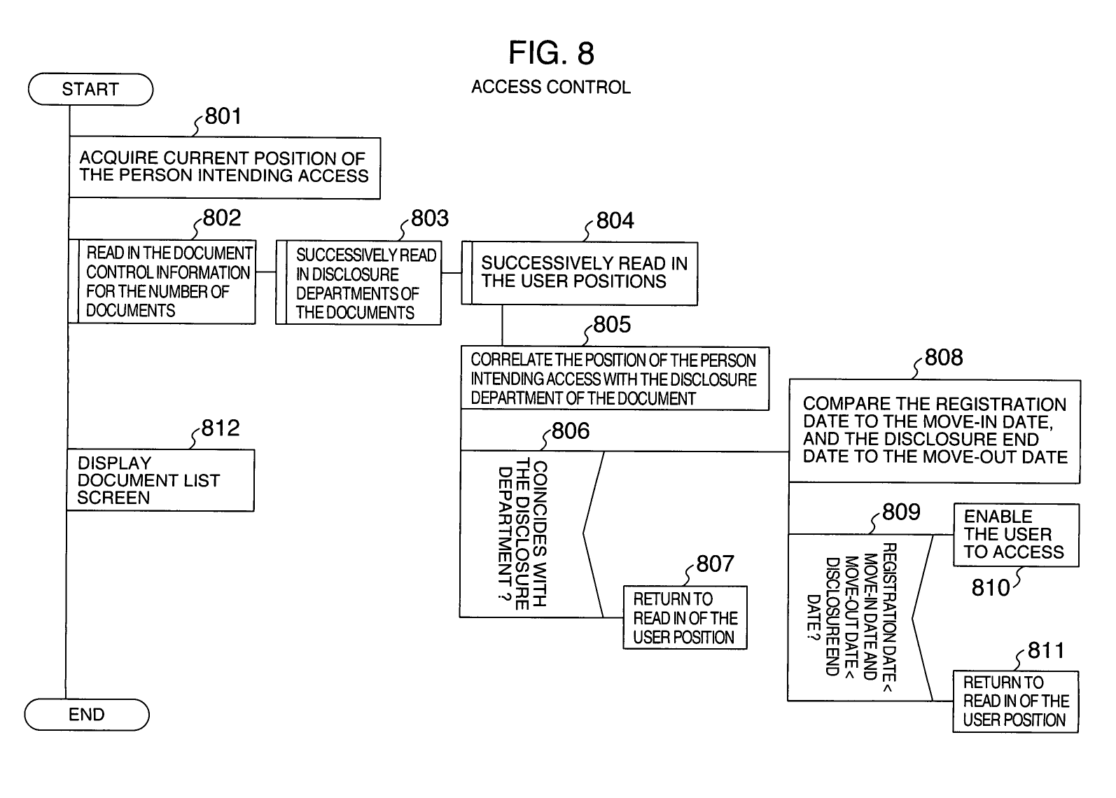

FIG. 8 is a PAD explaining operation of the access control process when a document list is requested. Next, referring to FIG. 8, explanation will be given on the flow of the access control process. This process is executed by the access control program 111.

(1) When a document list is requested by a user, the access control program 111 acquires the current position of the person intending to perform reference, from the personnel rotation information 122 according to the user ID inputted from the terminal device 101 (step 801).

(2) Next, the document access control information 121 is successively read in and the processes from step 803 to step 811 are repeated until the processes for all the documents are complete (step 802).

(3) For the documents which have been read in, the disclosure departments are successively read in, starting from the new one. Furthermore, for the personnel rotation history of the person intending an access, positions are successively read in starting from the new one (steps 803, 804).

(4) The document disclosure department is correlated to the department to which the person intending an access so as to judge whether the document disclosure department coincides with the department to which the person intending an access. When the departments do not coincide, control is returned to the process of step 804 for reading the position of the person intending an access (steps 805 to 807).

(5) When step 806 judges that the disclosure department coincides with the department of the person intending an access, the registration data is compared to the move-out data as well as the disclosure end date is compared to the move-in date so as to judge whether the document has been disclosed while the person intending an access belonged to the disclosure department (step 808).

(6) The comparison of step 808 decides whether the move-out date is later than the registration date and the move-in date is earlier than the disclosure end date. When the move-out date is later than the registration date and the move-in date is earlier than the disclosure end date, it is judged that the document has been disclosed during the person is in the position and the reference of the document is enabled (steps 809, 810).

(7) When step 809 decides that the condition that the move-out date is later than the registration date and the move-in date is earlier than the disclosure end date is not satisfied, that is, when the condition:
registration date<move-out date and move-in date<disclosure end date

is not satisfied, it is judged that the document was not disclosed while the person was in the position, and control is returned to the process of step 804 for reading a position of the person intending an access (step 811).

(8) After the access control is complete for all the documents, the document summary display program 112 displays a document list screen on the terminal device 101 (step 812).

Next, referring to FIG. 2 and FIG. 8, explanation will be given on a specific example of the access control process.

Suppose that a user of the user ID 0001 currently belonging to the department G as is described in the personnel rotation history 202 has made a request for a document list. In this case, firstly, the current disclosure department F of the document 201 of the document ID ZZZZ is correlated to the department G to which the person intending an access currently belongs (step 805). As a result of the correlation, the department G as the department to which the person intending an access currently belongs is found to be different from the department F as the document disclosure department. Accordingly, a preceding-by-one department of the person intending an access is read in (step 804). The preceding-by-one department A of the person intending an access is correlated to the current disclosure department F of the document (step 805). As a result of this correlation, it is found that the preceding-by-one department A of the person intending an access is different from the document disclosure department F and control is returned to the process for reading the departments to which the user belonged (step 807). Since the person intending an access did not belong to that department, next, the preceding-by-one disclosure department A of the document ID ZZZZ is read in (step 803). Again, the departments to which the person intending an access belonged and belongs is read in starting from the new one and the preceding-by-one disclosure department A of the document is correlated to the department G to which the person intending an access currently belongs (step 805). Since the preceding-by-one disclosure department A of the document is different from the department G to which the person intending an access, the preceding-by-one department to which the person intending an access belonged is read in (step 804). The preceding-by-one department A of the document coincides with the preceding-by-one department A of the person intending an access. Next, the registration date is compared to the move-out date and the disclosure end date is compared to the move-in date (step 808). The move-out date, i.e., Mar. 3, 2003 is later than the document registration date, i.e., Mar. 2, 2000; and the move-in date, i.e., Jan. 8, 2003 is earlier than the disclosure end date, i.e., Dec. 8, 2003. Accordingly, it is judged that while the person intending an access belonged to the department A, the document of the document ID ZZZZ was disclosed in the department A and the reference is allowed (step 810). As has been described above, it is judged whether to allow reference of the document by correlating the disclosure department with the department to which the person intending an access belonged or belongs for all the documents registered and comparing the registration date to the move-out date and the disclosure end date to the move-in date.

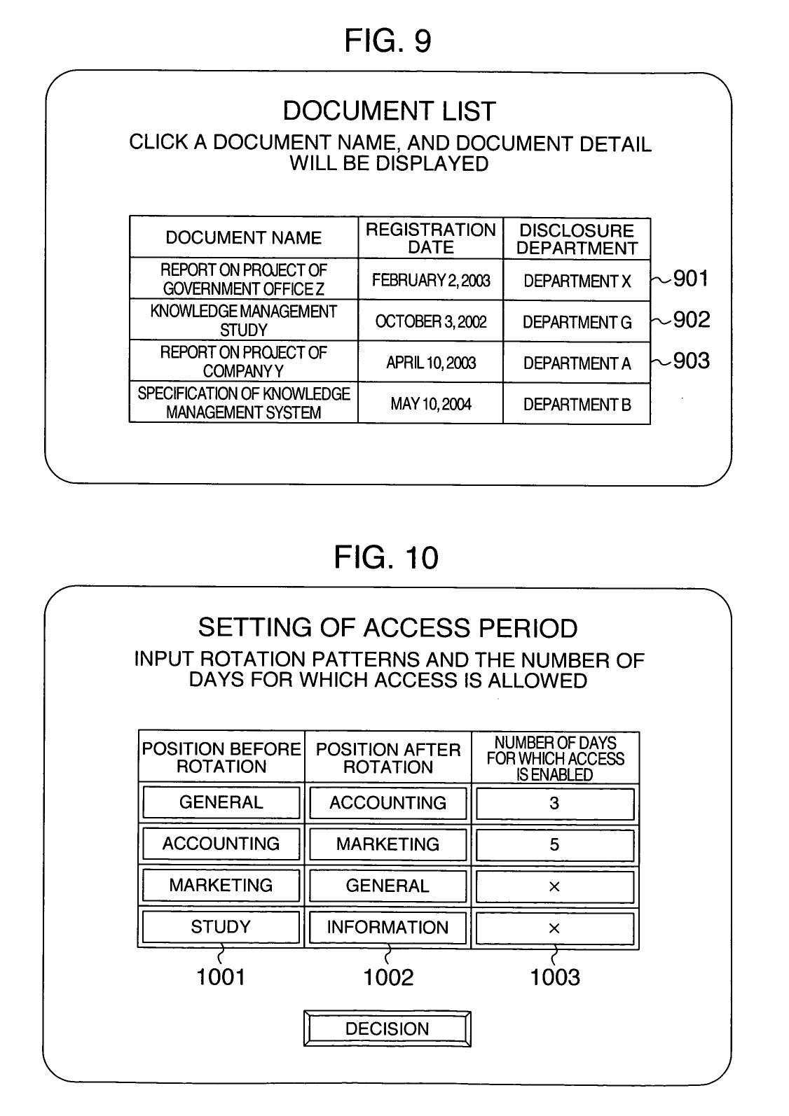

FIG. 9 shows an example of a display screen of the document list allowed to be referenced. The example of this display screen is displayed as the result of the processes explained with reference to FIG. 8.

In the example of FIG. 9, for example, the name of the document “Report on project of government office Z” 901 which was disclosed in the department A while the person intending an access belonged to the department A and the name of the document “Knowledge management study” 902 which is disclosed in the department G to which the person intending an access currently belongs are underlined and links to these documents are set. On the other hand, the document “Report on the project of company Y” 903 which has been registered in the department A was not disclosed while the person intending an access belonged to the department A. Accordingly, no link for reference is set.

The aforementioned processes may be configured as a processing program and the processing program may be stored in a recording medium such as HD, DAT, FD, MO, DVD-ROM, CD-ROM so as to be provided.

As has been described above, in this embodiment, the personnel rotation history of the person intending an access and the document disclosure department history are recorded and when reference is required, the personnel rotation history is correlated with the disclosure department history so that reference can be allowed even for an exclusive document if the document has was disclosed while the person intending an access belonged to the department. Thus, when an organization is changed and the person in charge moves to another department and the document disclosure department is changed to a department which is different from the department to which the person in charge belongs, the person in charge can use the system and acquire a necessary document.

It should be noted that in the aforementioned embodiment, as is shown in FIG. 1, as the information for document access control, the document access control information 121 is prepared separately from the document information 124 for storing the document. However, the document information may also store the document attribute information for performing document access control. Moreover, instead of performing the document access control before displaying the document list, it is also possible to perform the document access control before displaying the document detail after a document in the document list is clicked. Moreover, it is also possible to perform the access control before displaying the document list so that the document list contains only the documents which can be accessed.

Moreover, in the aforementioned embodiment, as is shown in FIG. 1, explanation has been given on that the entire-company information system 108 contains the position information 131 having the positions of the users who use the knowledge sharing server 103 and the service change information 132 which defines which department takes over which service upon an organization change. However, the position information 131 and the service change information 132 may be contained in the knowledge sharing server 103.

Moreover, the access period of an exclusive document which has been disclosed in the department to which the user belonged in the past may be specified and set by the user. Thus, the user can skip the documents which need not be referenced. Moreover, among the shared documents, there is a document which does not allow access, according to the characteristics of the document, for a person in charge who has moved to another department. In order to improve security of such a document, an access period of an exclusive document of another department may be set according to the rotation pattern or it is possible to inhibit reference of the exclusive document of the another department at all.

FIG. 10 shows an example of an access period selection screen having a position-before-rotation input form 1001, a position-after-rotation input form 1002, and a number-of-access-enabled-days input form 1003. By using this screen, the system administrator can set a personnel rotation pattern and the number-of-access-enabled-days for each document so that the access period is limited according to the personnel rotation pattern. Thus, it is possible to control the security according to the characteristics of the documents.

It should be noted that according to the present embodiment, it is possible to modify the document disclosure scope to an appropriate department upon an organization change without causing a load on the administrator. Moreover, even when a person in charge moves to another department, the person can continuously access the exclusive document which he has accessed in the former department. Thus, the person in charge can reduce the time required for acquiring a necessary document and improve the efficiency of the work requiring the document.

It should be further understood by those skilled in the art that although the foregoing description has been made on embodiments of the invention, the invention is not limited thereto and various changes and modifications may be made without departing from the spirit of the invention and the scope of the appended claims.

1. A disclosure control system for controlling disclosure of a document to be accessed, the system comprising:
storage means for storing document information on the document to be accessed and document access control information indicating the access authority of the document information;
service change information acquisition means for acquiring service change information concerning change of a service corresponding to the document information;
disclosure scope change means for comparing the service identifier corresponding to the service to be changed and contained in the service change information acquired with the service identifier contained in the document access control information and changing the department-in-charge corresponding to the matched service identifier in the document access control information if the identifiers are matched;
position information acquisition means for acquiring user position information corresponding to the access request when an access request is made for the document information stored; and
access control means for referencing the document access control information so as to decide whether the access to the document information is to be enabled or disabled.

2. A disclosure control system as claimed in claim 1, wherein
the storage means stores former position information indicating the former position of a user; and
the position information acquisition means compares the current position contained in the position information acquired for a user, with the former position contained in the former position information on the user and updates the former position corresponding to the former position information on the user to the current position if the current position is different from the former position.

3. A disclosure control system as claimed in claim 2, wherein
the storage means stores the personnel rotation history indicating the history of the user position rotation; and
the position information acquisition means updates the personnel rotation history corresponding to the user if the current position is different from the former position.

4. A disclosure control system as claimed in claim 3, wherein the personnel rotation history includes the current and the former position of the user and the move-out date and the move-in date from/to the positions.

5. A disclosure control system as claimed in claim 1, wherein
the document control information includes a document identifier corresponding to the document, the registration date of the document, the end date of the document disclosure to users, the disclosure department of the document, and a service identifier corresponding to the document.

6. A disclosure control system as claimed in claim 2, wherein
the former position information includes a user ID of an user and the user position of the preceding date.

7. A disclosure control system as claimed in claim 1, wherein
the service change information includes a service identifier corresponding to a service to be changed, the department in charge of the service before the change and the department in charge of the service after the change.

8. A disclosure control system as claimed in claim 5, wherein
the personnel rotation history includes the move-out date, the current position, and the move-in date of the user; and
when the current position contained in the user position information corresponding to the access request coincides with the disclosure department of the document, the access control means compares the document registration date with the user move-in date and the document disclosure end date with the user move-out date, thereby deciding whether to allow access.

9. A disclosure control method in a knowledge sharing system disclosing information to a user upon a request from the user, the method comprising steps of:
storing document information to be disclosed;
registering information on a plurality of users who access the document information;
accumulating the position history of each of the users;
correlating the position history with the registration date and the disclosure department of the document information; and
allowing disclosure of the document information if the correlation results in that the document information was disclosed to the department while the user corresponding to the request belonged to the department.

10. A disclosure control method as claimed in claim 9, the method further comprising steps of:
accumulating the department to which the document information is to be disclosed, the registration date of the document information, and the disclosure end date of the document information as a disclosure history;
correlating the disclosure history with a user position history; and
allowing disclosure of the information if the information was disclosed to the department while the user requesting the access to the document information belonged to that department.

11. A disclosure control method as claimed in claim 10, the method further comprising steps of:
accepting specification of a period during which a user whose position has been changed cab access the document information disclosed to the department to which the user belonged; and
allowing disclosure of the information during the specified period.

12. A disclosure control method as claimed in claim 11, the method further comprising steps of:
accepting specification of a combination of the position rotation concerning the department to which the document information is to be disclosed; and
allowing disclosure of the information to the limited department for the user corresponding to the specified combination.

13. A disclosure control method as claimed in claim 11, the method further comprising steps of:
accepting specification of an access period for each of the specified position rotation among the departments to which the document information is to be disclosed; and
allowing disclosure of the information to the limited departments during the specified period.

14. A disclosure control method as claimed in claim 9, the method further comprising steps of:
storing the former position information which is information on the position of the user of the preceding date; and
comparing the current position of a user contained in the user information to the former position information on the user and, if they are different, updating the former position information corresponding to the user to the current position of the user.

15. A disclosure control method as claimed in claim 9, wherein
the position history of the user includes the current and the former position of the user and the move-in date to the position and the move-out date from the position.

16. A disclosure control method as claimed in claim 9, the method further comprising steps of:
acquiring service change information concerning a change of a service corresponding to the document information; and
comparing a service identifier corresponding to a service to be changed and contained in the acquired service change information, with a service identifier contained in the document control information and, if they coincide, changing the department-in-charge to the coinciding service identifier.

17. A disclosure control method as claimed in claim 16, wherein
the service change information includes a service identifier corresponding to a service to be changed, a department-in-charge before the service change and a department-in-charge after the service change.

18. A program for executing a disclosure control method for controlling disclosure of document information by using a computer, the program comprising steps of:
storing document information on the document to be accessed and document access control information indicating the access authority of the document information;
acquiring service change information concerning a change of a service corresponding to the document information;
comparing the service identifier corresponding to the service to be changed and contained in the service change information acquired, with the service identifier contained in the document access control information and, if they coincide, changing the department-in-charge corresponding to the coinciding service identifier in the document access control information;
acquiring user position information corresponding to the access request when an access request is made for the document information stored; and
referencing the document access control information so as to decide whether the access to the document information is to be enabled or disabled.

19. A program as claimed in claim 18, the program further comprising steps of:
storing the former position information indicating the former position information on the user;
comparing the current position contained in the position information acquired for a user, with the former position contained in the former position information on the user; and
if the current position and the former position of the user are different, updating the former position corresponding to the former position information on the user to the current position.

20. A program as claimed in claim 19, the program further comprising steps of:
storing rotation history indicating the history concerning rotation of the positions of the user; and
if the current position is different from the former position, updating the rotation history corresponding to the user.
